(19) United States
(12) Patent Application Publication
(10) Pub. No.: US 2012/0159940 A1
(43) Pub. Date: Jun. 28, 2012

(54) Pressure Regulating Device, Compressed Air Supply System and Motor Vehicle

(76) Inventor: Yang Cong, Shenzhen (CN)

(21) Appl. No.: 13/318,275

(22) PCT Filed: May 4, 2010
(86) PCT No.: PCT/CN10/72410

§ 371 Date: Jan. 12, 2012

(30) Foreign Application Priority Data
May 1, 2009 (CN) 200910107193.X

(51) Int. Cl. F15B 13/042; F16K 31/124

(52) U.S. Cl. 60/407; 137/491

(57) ABSTRACT

A pressure regulating device, a compressed air supply system and a motor vehicle are provided. The pressure regulating device comprises a first valve seat (301), a first valve plug (302), a second elastic body (314) and a first gas pipeline (307). A sliding sealing fit is provided between the first valve plug (302) and the first valve seat (301), and the first valve plug (302) divides the first valve seat (301) into a first chamber (305) and a second chamber (306). The second elastic body (314) is arranged in the second chamber (306) and supports the first valve plug (302). The first chamber (305) is connected with the first gas pipeline (307). The first valve plug (302) has at least two branch airways (323), each of which having a gas outlet (325). The first valve plug (302) has at least two third positions in which at least one gas outlet (325) is closed by the inner wall (321) and at least one of other gas outlets (325) leaves the inner wall (321). Gas flux and gas pressure are regulated through operation of a controller (400), making the first valve plug (302) move upward and downward, thus facilitating an easy regulating of gas flux and gas pressure in the fourth gas pipeline (310).

### TECHNICAL FIELD

The present application relates to a pressure regulating device, a compressed air supply system and a motor vehicle.

### BACKGROUND

U.S. Pat. No. 7,641,005 B2 issued to the applicant of the present application provides an engine comprising left and right wind-powered pneumatic engines arranged symmetrically. Each of the left and right wind-powered pneumatic engines comprises an impeller chamber as well as impeller and vanes arranged therein. Compressed air is used in the engine as main power, and external wind resistance are received for use as auxiliary power, thereby driving the impellers and vanes to operate to generate power output.

The above invention firstly proposed a wind-powered pneumatic engine which utilizes compressed air as the main power to directly drive the impeller and directly utilizes the wind resistance airflow as the auxiliary power, and a motor vehicle in which the need of converting wind resistance airflows into electrical power and the need of a complex mechanic-electric energy conversion system are eliminated, an the structure thereof is simplified, which renders a motor vehicle free of pollution. Based on the aforementioned application, another U.S. patent application Ser. No. 12/377,513 (WO 2008/022556) filed by the applicant provides a combined wind-powered pneumatic engine. In view of a high speed and relatively centralized features of a high pressure airflow and a low speed and relatively dispersive features of a wind resistance airflow, the application Ser. No. 12/377,513 provides separately an independent high pressure pneumatic engine and a wind resistance wind resistance engine which operate independently from each other, thereby further optimizing the performance of the wind-powered pneumatic engine and improving the operating efficiency of the wind-powered pneumatic engine and hence the motor vehicle.

However, the above mentioned wind-powered pneumatic engine and motor vehicle using compressed air as the source of main power are still a new technology. Therefore, there remains a need of further perfection and improvement to the structure of the wind-powered pneumatic engine and the motor vehicle employing the wind-powered pneumatic engine as discussed above.

### SUMMARY OF THE INVENTION

The object of the present application is to provide a pressure regulating device, a compressed air supply system and a motor vehicle which are easy for operation.

In accordance with an aspect of the present application, a pressure reducing valve assembly comprises a first control valve and a second control valve. The first control valve comprises: a first valve seat having a cavity, a first valve plug provided within the cavity dividing the cavity into a first chamber and a second chamber, the first chamber outputting gas through a conduit, a second elastic body provided within the second chamber, connected at one end to the first valve seat and at another end to the first valve plug, a first gas pipeline having a junction with the first chamber, a second gas pipeline communicating at one end with the first gas pipeline and at another end with the second chamber, and a third gas pipeline communicating at one end with the first chamber and at another end with the second chamber. The first valve plug blocks the junction at a first position, and is apart from the first gas pipeline at a second position. The second control valve is provided within the third gas pipeline and is provided with a second valve seat and a second valve plug being controlled and movable with respect to the second valve seat, and the second valve plug, along its motion track, has a position in which the third gas pipeline is blocked and a position in which the third gas pipeline is unblocked.

In accordance with another aspect of the present application, a pressure reducing valve assembly comprises a first control valve and a second control valve. The first control valve comprises: a first valve seat having a cavity, a first valve plug provided within the cavity dividing the cavity into a first chamber and a second chamber, the first valve plug slidably and sealingly fitted with the first valve seat, a second elastic body provided within the second chamber and supporting the first valve plug, a first gas pipeline communicating with the first chamber, a second gas pipeline connected to the first gas pipeline and the second chamber, a third gas pipeline connected to the first chamber and the second chamber, having a cross section greater than that of the second pipeline, and a fourth gas pipeline communicating with the first chamber. The second control valve is connected to the third gas pipeline to control the flow of the third gas pipeline. The first valve plug blocks the first gas pipeline at a first position along a sliding direction to disconnect the first gas pipeline from the first chamber, and is apart from the first gas pipeline at a second position along the sliding direction to make the first gas pipeline communicate with the first chamber.

In accordance with another aspect of the present application, a pressure regulating device comprises a control valve and a controller. The control valve comprises: a first valve seat having a cavity, a first valve plug provided within the cavity dividing the cavity into a first chamber for outputting a gas and a second chamber, a second elastic body provided within the second chamber and connected at one end to the first valve seat and at another end to the first valve plug, a first gas pipeline having a junction with the first chamber, a second gas pipeline communicating at one end with the first gas pipeline and at another end with the second chamber, and a third gas pipeline communicating at one end with the first chamber and at another end with the second chamber. The first valve plug blocks the junction at a first position, and is apart from the first gas pipeline at a second position. The controller is provided within the third gas pipeline and is provided with a second valve seat and a second valve plug being controlled and movable with respect to the second valve seat. The second valve plug, along its motion track, has a position in which the third gas pipeline is blocked and a position in which the third gas pipeline is unblocked.

In accordance with another aspect of the present application, a pressure regulating device comprises a control valve and a controller. The control valve comprises: a first valve seat having a cavity, a first valve plug provided within the cavity dividing the cavity into a first chamber and a second chamber, the first valve plug slidably and sealingly fitted with the first valve seat, a second elastic body provided within the second chamber and supporting the first valve plug, a first gas pipeline communicating with the first chamber, a second gas pipeline connected to the first gas pipeline and the second chamber, a third gas pipeline connected to the first chamber and the second chamber, and having a cross section greater than that of the second pipeline, and a fourth gas pipeline communicating with the first chamber. The controller is connected with the third gas pipeline to control the flux of the third gas pipeline. The first valve plug blocks the first gas pipeline at a first position along a sliding direction to disconnect the first gas pipeline from the first chamber, and moves away from the first gas pipeline at a second position along the sliding direction to make the first gas pipeline communicate with the first chamber.

In accordance with another aspect of the present application, a pressure regulating device comprises a first valve seat having a cavity, a first valve plug provided within the cavity for dividing the cavity into a first chamber and a second chamber, the first valve plug being slidably and sealingly fitted with the first valve seat, a second elastic body provided within the second chamber and supporting the first valve plug, and a first gas pipeline communicating with the first chamber. A portion of the first valve plug located inside the first chamber is provided with at least two branch airways. Each branch airway has a gas outlet and a gas inlet communicating with the first gas pipeline. The first valve plug has a first position, a second position and at least two third positions along its sliding direction. When the first valve plug is at the first position, all the gas outlets are blocked by the inner wall of the first gas pipeline. When the first valve plug is at the second position, the inner wall of the first gas pipeline is away from all the gas outlets. When the first valve plug is at the third position, at least one of the gas outlets is blocked by the inner wall of the first gas pipeline whilst at least one of other gas outlets is away from the inner wall.

In accordance with another aspect of the present application, a compressed air supply system comprises a compressed air tank, a gas distributor for feeding compressed air to a pneumatic engine, and a pressure reducing valve connecting the compressed air tank with the gas distributor.

In accordance with another aspect of the present application, a motor vehicle comprises a compressed pneumatic engine and a compressed air supply system. The gas distributor of the compressed air supply system is directly connected to the pneumatic engine.

Technical effects of the present application: 1) The flux and pressure of a gas in the third gas pipeline can be regulated through operation of the controller, thus making the first valve plug move up or down and thereby regulating a flux and pressure of the gas as an output in the fourth gas pipeline, which facilitates operation and control. 2) The flux and pressure of the compressed air are regulated via the pressure regulating device, and the compressed air after regulation is delivered directly to a pneumatic engine via a distributor, which shortens gas delivery pipeline, reduces loss of gas throughout the entire pipeline, and improves the efficiency of air utilization. 3) By arranging several branch airways, closure of the pressure regulating device can be achieved step by step, thereby reducing the vibratory shock while braking the motor vehicle. 4) The second gas pipeline has a diameter less than the third gas pipeline, which effects an amplification of flux and thus a precise control on the flux of gas in the fourth gas pipeline.

### BRIEF DESCRIPTION OF THE DRAWINGS

FIG. 1 is a plan view of a motor vehicle with a pressure regulating device, i.e., a pressure reducing valve assembly according to a first embodiment.

FIG. 2 is a schematic structural view of the pressure regulating device which is closed according to the first embodiment.

FIG. 3 is a schematic structural view of the pressure regulating device which is opened according to the first embodiment.

FIG. 4 is a schematic structural view showing a connection relationship among the pressure regulating device, a compressed air tank, a gas distributor and a transmission mechanism.

FIG. 5 is schematic structural view of a part of power system in a motor vehicle with a pressure regulating device according to a second embodiment.

FIG. 6 is a schematic structural view of the pressure regulating device being closed according to the second embodiment.

FIG. 7 is a schematic structural view of the pressure regulating device being opened according to the second embodiment.

FIG. 8 is a schematic structural view of the pressure regulating device being closed according to a third embodiment.

FIG. 9 is a schematic structural view of the pressure regulating device being opened according to the third embodiment.

FIG. 10 is an exploded view of a first valve plug according to the third embodiment.

FIG. 11 is a schematic structural view of a closing portion of a first valve plug in the pressure regulating device of the third embodiment.

FIG. 12 is a schematic structural view of a pressure regulating device according to a fourth embodiment.

FIG. 13 is a schematic structural view of a pressure regulating device according to a fifth embodiment.

FIG. 14 is a schematic structural view of a pressure regulating device according to a sixth embodiment.

FIG. 15 is a schematic structural view of a pressure regulating device being opened according to a seventh embodiment.

FIG. 16 is a schematic structural view of the pressure regulating device being closed according to the seventh embodiment.

### DETAILED DESCRIPTION

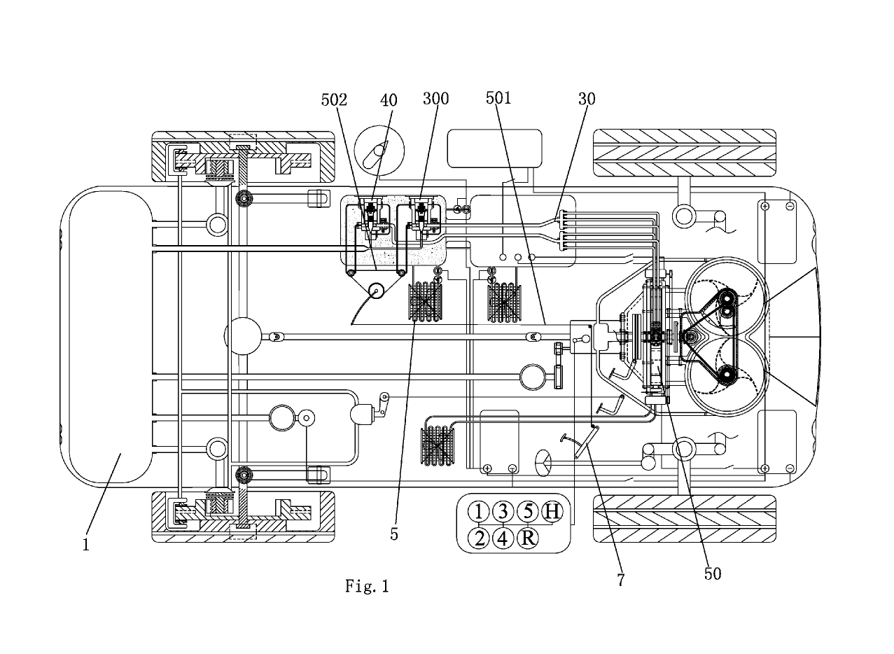

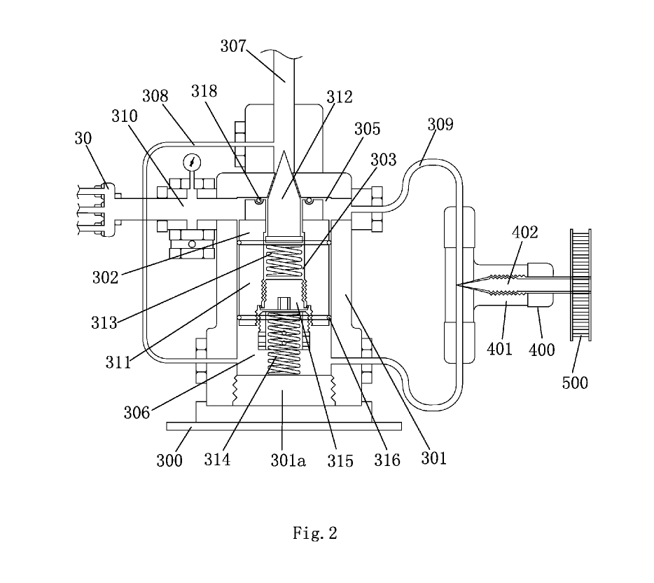

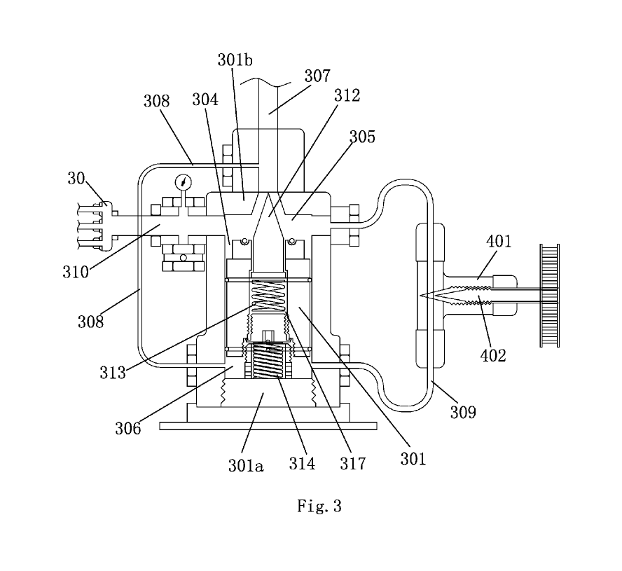

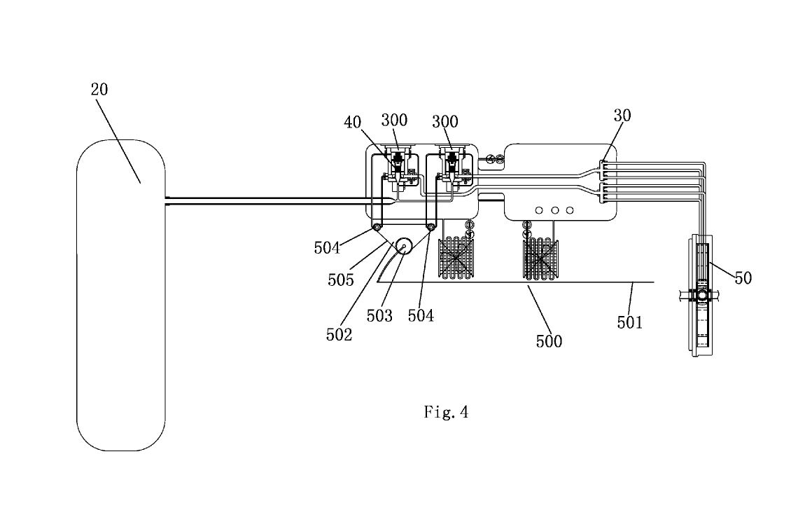

As shown in FIG. 1 to FIG. 4, a motor vehicle using compressed air as power source comprises a compressed air tank 20, a pneumatic engine 50, and a gas distributor 30 for feeding compressed air to the pneumatic engine 50. A pressure regulating device 40 which is a pressure reducing valve assembly is arranged between the gas distributor 30 and the compressed air tank 20.

The pressure reducing valve assembly 40 comprises a first control valve 300 and a second control valve 400. The first control valve 300 comprises a first valve seat 301 having a cavity 304, a first valve plug 302 provided within the cavity 304 and divides the cavity 304 into a first chamber 305 and a second chamber 306, and an elastic body 303. The first control valve 300 further comprises a first gas pipeline 307, a second gas pipeline 308, a third gas pipeline 309, and a fourth gas pipeline 310. The first gas pipeline 307 receives compressed air from the compressed air tank 20. The second gas pipeline 308 has one end communicating with the first gas pipeline 307 and another end communicating with the second chamber 306. The third gas pipeline 309 has one end communicating with the second chamber 306 and another end communicating with the first chamber 305 which communicates with the gas distributor 30 through the fourth gas pipeline 310.

The first gas pipeline 307 has a diameter greater than the second gas pipeline 308 and the third gas pipeline 309. The second gas pipeline 308 has a diameter less than the third gas pipeline 309. The first valve plug 302 has a close position and an open position with respect to the first valve seat 301. When the first valve plug 302 is at the close position, it blocks a junction between the first gas pipeline 307 and the first chamber 305 so that the first gas pipeline 307 does not communicate with the first chamber 305; when the first valve plug 302 is at the open position, it is apart from the junction between the first gas pipeline 307 and the first chamber 305 so that the first gas pipeline 307 communicates with the first chamber 305.

The first valve plug 302 comprises a columnar main body 311 and a closing portion 312 having a diameter less than that of the main body 311. The closing portion 312 has a needle-shaped head. The main body 311 is slidably fitted with the first valve seat 301. The periphery surface of the main body 311 is surrounded by a first elastic sealing ring 316, through which the main body 311 is sealingly fitted with the first valve seat 301. The main body 311 has an axially running through inner chamber 317 within which the closing portion 312 is disposed and linearly movable with respect to the main body 311. The elastic body 303 comprises a first elastic body 313 and a second elastic body 314. The first elastic body 313 bears at one end against the closing portion 312 and another end against a positioning block 315, respectively. The second elastic body 314 is fixed at one end to the bottom 301a of the first valve seat 301 and at another end to the positioning block 315, respectively. The positioning block 315 is fixed to the inner chamber 317 through thread fitting. A second elastic sealing ring 318 is fixed onto the top surface of the main body 311.

The second control valve 400 is arranged on the third gas pipeline 309 for controlling the flux in the third gas pipeline 309. The controller 400 comprises a hollow second valve seat 401 and a second valve plug 402 disposed in and linearly movable with respect to the second valve seat 401. The second valve plug 402 is thread fitted with the second valve seat 401. The second valve plug 402 is connected to the output port of a transmission mechanism 500, and the input port of the transmission mechanism 500 is coupled with a control switch 7 of a motor vehicle. The transmission mechanism 500 comprises a power connected first transmission mechanism 501 and a second transmission mechanism 502. The second transmission mechanism 502, which may be a belt transmission mechanism, comprises a driving pulley 503 and a driven pulley 504 having a less diameter than that of the driving pulley 503. A belt 505 is wound around the driving pulley 503 and the driven pulley 504. The first transmission mechanism 501 moves upon operation of the control switch 7, thus driving the driving pulley 503 to rotate, and then driving the driven pulley 504 to rotate by means of the belt 505. The driven pulley 504 drives the second valve plug 402 to rotate, rendering the second valve plug 402 screwed or unscrewed with respect to the second valve seat 401 so as to regulate the flux in the third gas pipeline 309.

When a compressed air does not enter the pressure regulating device 40, the head of the closing portion 312 blocks the junction between the first gas pipeline 307 and the first chamber 305 under the elastic force of the first and second elastic body 313, 314. At this time, there is a gap between the second sealing ring 318 and the top 301b of the first valve seat 301. When the compressed air enters the pressure regulating device 40, the compressed air aerates into the chamber 306 through the first gas pipeline 307 and the second gas pipeline 308. During the aeration, if the control switch 7 is not turned on, then the pressure of the second chamber 306 continues driving the first valve plug 302 to move toward the top 301b, allowing the head of the closing portion to block the junction stably, until the second sealing ring 318 bears against the 301b. When the control switch 7 is turned on, the second valve plug 402 is unscrewed, allowing the third gas pipeline 309 to be unblocked, and gas in the second chamber 306 flows to the first chamber 305 through the third gas pipeline 309, thus lowering the pressure in the second chamber 306. The pressure of the compressed air forces the closing portion 312 of the first valve plug 302 to leave the junction, allowing the compressed air to enter the distributor 30 through the first chamber 305 and the fourth gas pipeline 310. While the compressed air is entering the fourth gas pipeline 310 through the first chamber 305, the whole first valve plug 302 moves toward the bottom 301a of the first valve seat 301. While the compressed air tank 20 stops supplying gas, the closing portion 312 of the first valve plug 302 blocks the junction between the first gas pipeline 307 and the first chamber 305 again under acting forces of the first and second elastic body.

The first and second elastic body bodies may be for example a spring, or an elastic sleeve, clips, or other components capable of deforming expansively or elastically along the sliding direction of the first valve plug 302.

A precise on/off control on the gas output from the compressed air tank 20 to the gas distributor 30 can be realized by disposing the pressure regulating device. The second elastic body 313 acts as a buffer effectively reducing a rigid strike force from the main body 311 of the first valve plug 302 to the first valve seat 301, and meanwhile improving the air tightness provided by the closing portion 312 to the first gas pipeline 307. Since the second gas pipeline 308 has a cross section less than that of the third gas pipeline 309, control on the whole gas path of the control valve 300 can be achieved, and meanwhile a flux can be amplified so as to improve precision of control.

When two distributors are provided, two pressure regulating devices are provided corresponding to the two distributors and controlled by the same control switch. In this situation, the second transmission mechanism 502 may comprise two driven pulleys separately driving the second valve plugs of the two pressure regulating devices.

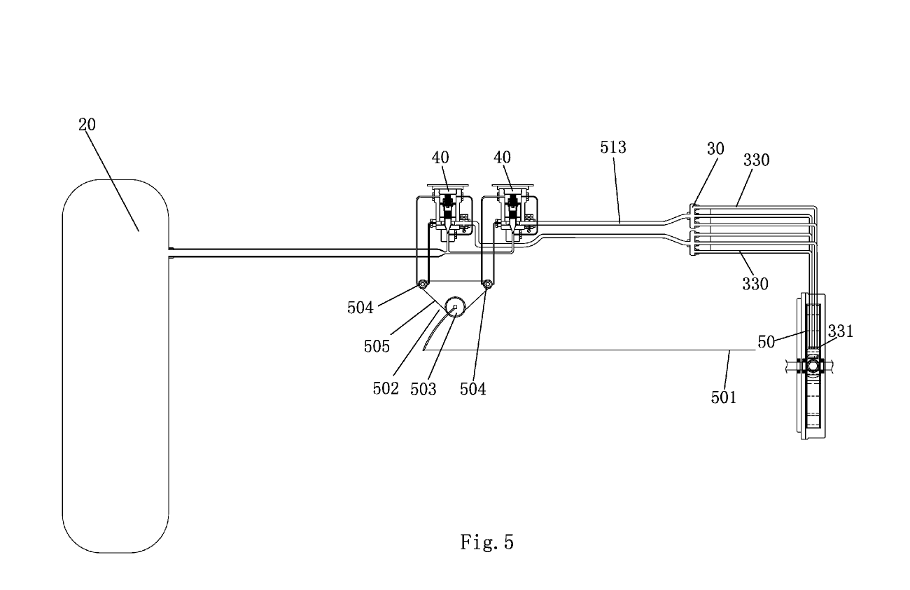

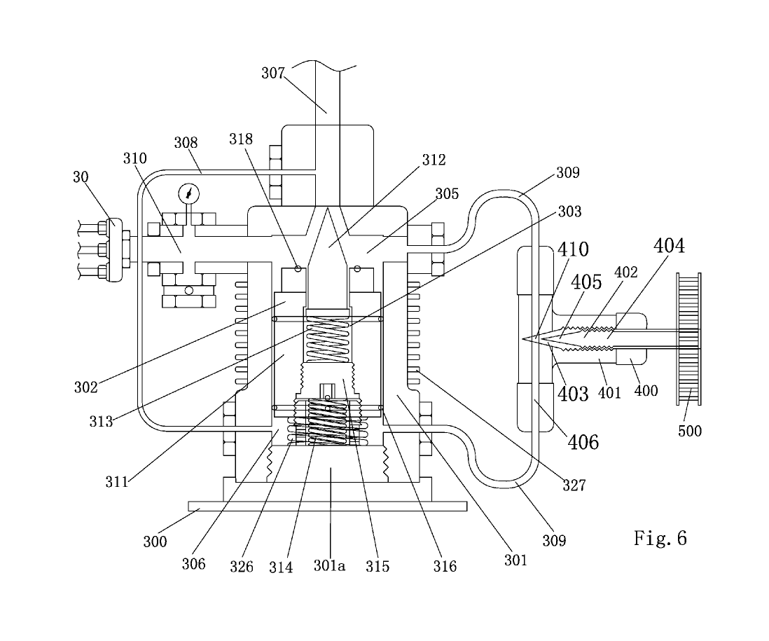

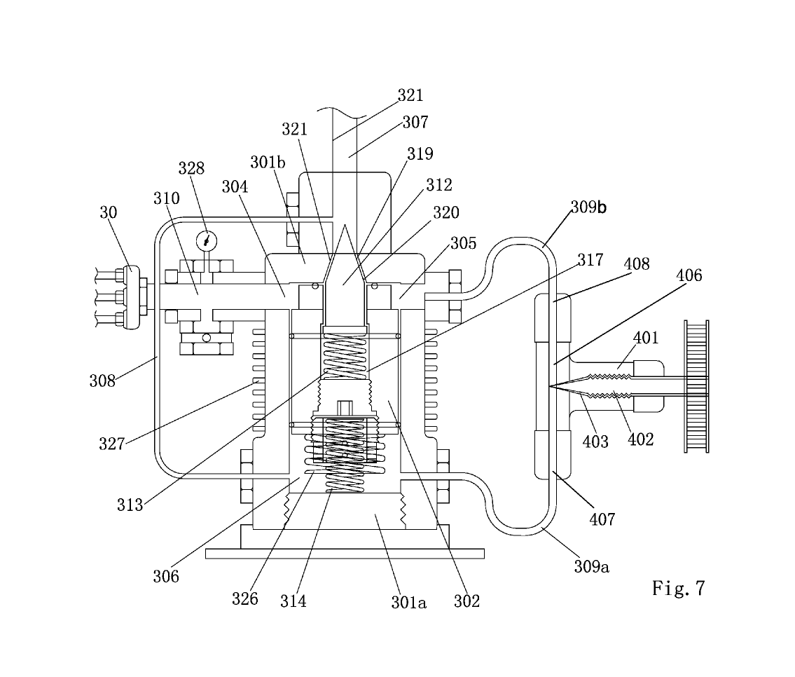

FIGS. 5 to 7 show a pressure regulating device according to a second embodiment of the present application. A pressure regulating device 40 for regulating the pressure (e.g. reducing pressure) and flux of gas is arranged between a compressed air tank 20 for storing compressed air and a gas distributor 30 of a motor vehicle. The gas distributor 30 serves to distribute the regulated gas into several paths for inputting the gas to a pneumatic engine 50 of a motor vehicle. The gas distributor 30 may comprise distribution pipelines 330 and a nozzle 331 for ejecting gas into the pneumatic engine 50 which drives the motor vehicle.

The pressure regulating device 40 comprises a control valve 300 and a controller 400. The control valve 300 comprises a first valve seat 301, a first valve plug 302 and an elastic body 303. The first valve seat 301 has a cavity 304. The first valve plug 302 is arranged in the cavity 304 and is slidably and sealingly fitted with the first valve seat 301. The first valve plug 302 in the cavity 304 divides the cavity 304 into a first chamber 305 and a second chamber 306. The control valve 300 further comprises a first gas pipeline 307, a second gas pipeline 308, a third gas pipeline 309 and a fourth gas pipeline 310. The first gas pipeline 307 is used to receive the compressed air input from a compressed air tank 20. The second gas pipeline 308 communicates at one end with the first gas pipeline 307, and at another end with the chamber 306. The third gas pipeline 309 communicates at one end with the second chamber 306, and at another end with the first chamber 305 which is linked to the distributor 30 via the fourth gas pipeline 310. The first gas pipeline 307 has a cross section greater than that of the second gas pipeline 308 and that of the third gas pipeline 309, and the second gas pipeline 308 has a cross section less than that of the third gas pipeline 309. The first valve plug 302 has a close position and an open position with respect to the first valve seat 301. When the first valve plug 302 is at the close position, it blocks the junction between the first gas pipeline 307 and the first chamber 305, so that the first gas pipeline 307 is disconnected from the first chamber 305; and when the first valve plug 302 is at open location, it is apart from the junction between the first gas pipeline 307 and the first chamber 305 so that the first gas pipeline 307 communicates with the first chamber 305.

The first valve plug 302 comprises a columnar main body 311 and a closing portion 312 with a less diameter than that of the main body 311 and having a needle-shaped head. The main body 311 is slidably fitted with the first valve seat 301. The periphery surface of the main body 311 is surrounded by a first elastic sealing ring 316, through which the main body 311 is sealingly fitted with the first valve seat 301. The main body 311 has an axially running through inner chamber 317 in which the closing portion 312 extending into the chamber 305 is disposed and linearly movable with respect to the main body 311. The elastic body 303 comprises a first elastic body 313 and a second elastic body 314. The first elastic body 313 is disposed in the inner chamber 317, with its two ends bearing against the closing portion 312 and a first positioning block 315, respectively. The second elastic body 314 is disposed in the second chamber 306 and is fixed at one end to the bottom 301a of the first valve seat 301 and at another end to the first positioning block 315. The first positioning block 315 is fixed through thread fitting to the bottom of the inner chamber 317. A second elastic sealing ring 318 is fixed onto the top surface of the main body 311.

The controller 400 is disposed on the third gas pipeline 309 for controlling the gas flux in the third gas pipeline 309. The control on gas flux may comprise controlling changes between flow and non-flow as well as between large flow and small flow. The controller 400 comprises a hollow second valve seat 401 and a second valve plug 402. The second valve plug 402 comprises a second main body 404 and a conical body 405 located at the front end of the second main body 404. The second valve seat 401 is provided with a gas passage 406 having a gas inlet 407 and a gas outlet 408. A control cavity 410 which is cone-shaped corresponding to the cone body is provided within the gas passage 406. The second main body 404 is thread fitted with the control cavity 410 so that a second gap 403 between the second main body 403 and the control cavity 410 can be adjusted through the thread, thereby a gas flux in the third gas pipeline 309 is controlled. The third gas pipeline 309 may be divided into a first section 309a and a second section 309b. The first section 309a is connected to the gas inlet 407 of the gas passage 406 and the second chamber 306, and the second section 309b is connected to the gas outlet 408 of the gas passage 406 and the first chamber 305. It can be understood for the persons in the art that the controller 400 may be implemented by other conventional airflow control means. The second valve plug 402 is connected to the output port of a transmission mechanism 500, and the input port of the transmission mechanism 500 is coupled with a control switch of a motor vehicle. The transmission mechanism 500 comprises a second transmission mechanism 502 and a power connected first transmission mechanism 501 connecting the control switch with the second transmission mechanism 502. The second transmission mechanism 502, such as a belt transmission mechanism, comprises a driving pulley 503 and a driven pulley 504 having a less diameter than that of the driving pulley 503. A belt 505 is wound around the driving pulley 503 and the driven pulley 504. The first transmission mechanism 501 moves according to an operation of the control switch to drive the driving pulley 503 to rotate, which further drives the driven pulley 504 to rotate by means of the belt 505. The driven pulley 504 drives the second valve plug 402 to rotate, rendering the second valve plug 402 screwed or unscrewed with respect to the second valve seat 401. In other words, the regulation of the flux of the third gas pipeline is carried out by changing size of the second gap 403. When the second gap 403 becomes zero, the controller 400 is closed, and the third gas pipeline 309 is disconnected.

When the compressed air does not enter the pressure regulating device, the head of the closing portion 312 blocks the junction between the first gas pipeline 307 and the first chamber 305 under the elastic force of the first and second elastic body 313, 314. At this moment, there is a gap between the second sealing ring 318 and the top 301b of the first valve seat 301 (or the second sealing ring 318 has reached the top 301b). When the compressed air enters the pressure regulating device, the compressed air aerates into the chamber 306 through the first gas pipeline 307 and the second gas pipeline 308. During aeration, if the control switch is not turned on, then the pressure of the second chamber 306 continues driving the first valve plug 302 to move toward the top 301b, allowing the head of the closing portion to block up the junction (a peripheral surface 320 of the closing portion 312 clings to the inner wall 321 of the first gas pipeline 307) stably, until the second sealing ring 318 bears against the 301b (or the second sealing ring 318 presses against the top 301b after being elastically deformed). When the control switch is turned on, the second valve plug 402 is unscrewed, allowing the third gas pipeline 309 to be unblocked, and gas in the second chamber 306 flows to the first chamber 305 through the third gas pipeline 309, rendering a reduction of the pressure in the second chamber 306. The pressure of the compressed air forces the closing portion 312 of the first valve plug 302 leaves the junction, allowing the compressed air to enter the distributor 30 through the first chamber 305 and the fourth gas pipeline 310. While the compressed air is entering the fourth gas pipeline 310 through the first chamber 305, the whole first valve plug 302 moves toward the bottom 301a of the first valve seat 301. When forces applied to the first valve plug 302 become equilibrium, the main body 311 and the closing portion 312 stay still with respect to each other. A first gap 319 for passage of the compressed air is then formed between the periphery surface 320 of the closing portion 312 and the inner wall 321 of the first gas pipeline 307. While the compressed air tank 20 stops supplying gas, the closing portion 312 of the first valve plug 302 blocks the junction between the first gas pipeline 307 and the first chamber 305 again under forces applied by the first and second elastic body, with the closing portion 312 clinging to the inner wall of the first gas pipeline 307.

In addition, a radiator 327 may be provided at the external of the first valve seat 301 of the control valve 300. A third elastic body 326 may be suspended under the bottom of the first valve plug 302. When the closing portion 312 of the first valve plug 302 blocks the first gas pipeline 307, the third elastic body 326 is suspended without contacting the bottom 301a of the first valve seat 301. When the closing portion 312 is moving downward, the second elastic body 314 is continuously compressed, whilst the third elastic body 314 moves downward firstly and is compressed till it contacts the bottom 301a of the first valve seat 301. A multistage control of the flux and pressure of gas in the fourth gas pipeline 310 can be carried out through the cooperation of the second elastic body 314 and third elastic body 326. A barometer 328 may also be provided at the first valve seat 301 for monitoring an air pressure inside the fourth gas pipeline 310.

The flux and pressure of gas in the third gas pipeline 309 may be regulated through operation of the controller 400, which makes the closing portion 312 move up or down and leads to change of the first gap 319 between the inner wall of the first gas pipeline 307 and the periphery surface of the closing portion 312, thereby regulating the flux and pressure of gas in the fourth gas pipeline 310.

The first, second and third elastic bodies may be for example a spring, or an elastic sleeve, clips, or other components capable of deforming expansively or elastically along the sliding direction of the first valve plug 302.

With such a pressure regulating device, compressed air in the compressed air tank is output to the distributor after the air pressure is regulated. The second elastic body 313 acts as a buffer effectively reducing a rigid strike force from the main body 311 of the first valve plug 302 to the first valve seat 301, and meanwhile improving the air tightness provided by the closing portion 312 to the first gas pipeline 307. Since the second gas pipeline 308 has a cross section less than that of the third gas pipeline 309, control on the whole gas path of the control valve 300 can be achieved, and meanwhile a flux can be amplified so as to improve precision of control.

When two distributors are provided, two pressure regulating devices are provided corresponding to the two distributors and controlled by the same control switch. In this situation, as shown in FIG. 5, the second transmission mechanism comprises two driven pulleys separately driving the second valve plugs of the two pressure regulating devices. In other examples, more than two pressure regulating devices in series may be provided in order to achieve multistage control of the compressed air input to the gas distributor.

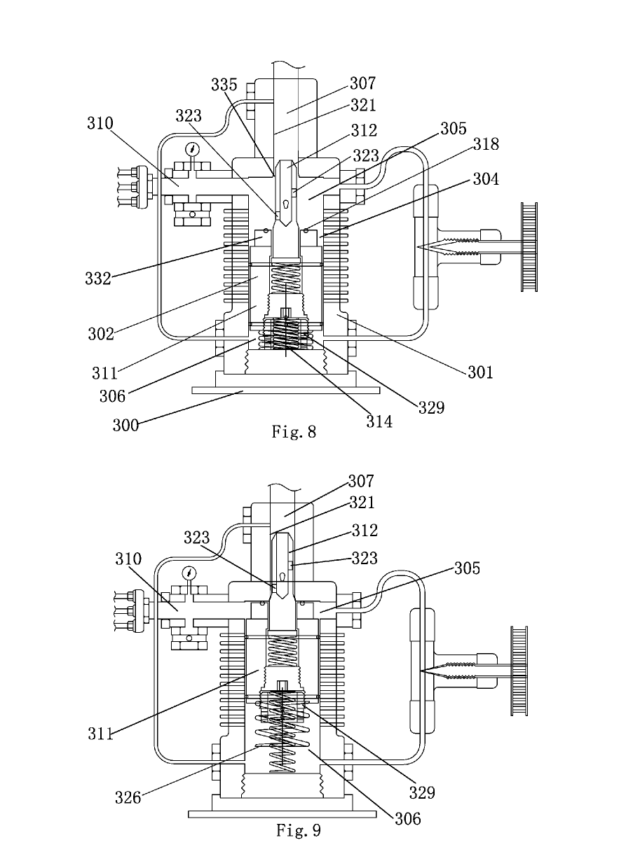

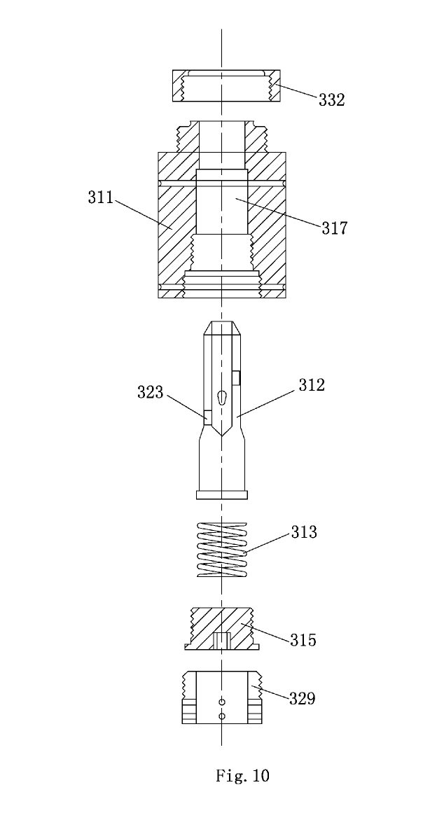

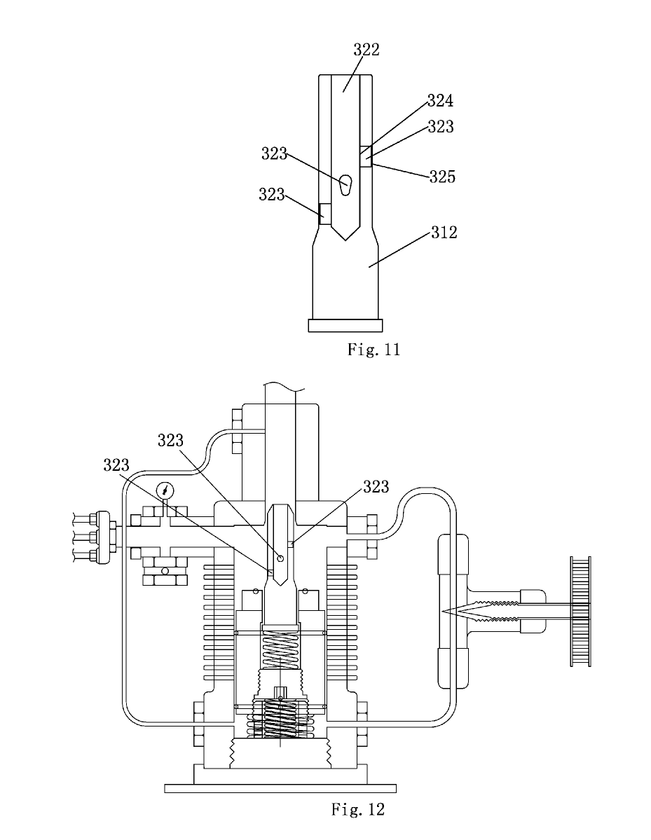

FIG. 8 to FIG. 11 illustrates a third embodiment of the pressure regulating device. The primary difference between this embodiment and the second embodiment lies in the structure of the first valve plug. The control valve 300 comprises a first valve seat 301, a first valve plug 302, a first elastic body 303, a second elastic body 314 and a third elastic body 326. The first valve seat 301 has a cavity 304, in which a first valve plug 302 is disposed dividing the cavity 304 into a first chamber 305 and a second chamber 306. The first valve plug 302 comprises a columnar main body 311 and a columnar closing portion 312 having a diameter less than that of the columnar main body 311. A periphery surface 320 of the closing portion 312 is slidably and sealingly fitted with an inner wall 321 of the first gas pipeline 307. The closing portion 312 is provided with an axially extended main airway 322 and at least one radially running through branch airway 323. The main airway 322 is connected to the first gas pipeline 307, and the branch airway 323 has a gas inlet 324 communicating with the main airway 322 and a gas outlet 325. Alternatively, several independent branch airways instead of the main airway 322 may be arranged in the closing portion.

The first valve plug 302 further comprises a first positioning block 315 and a second positioning block 329. The main body 311 has an axially running through inner cavity 317. The first positioning block 315 is fixed to the bottom of the inner chamber 317 through thread fitting. The second positioning block 329, which is also fixed to the bottom of the inner chamber 317 through thread fitting, is disposed under the first positioning block 315. A third elastic body 326 is hung on the second positioning block 329. The second elastic body 314 extends up through the second positioning block 329 to be connected to the first positioning block 315. The first valve plug 302 may further be provided with a top cover 332 in thread fitting with the top of the main body 311. A second sealing ring 318 is disposed onto the end face of the top cover 332.

When a controller 400 is turned off, the whole first valve plug 302 moves up, and the top gas outlet 325 is firstly blocked by an inner wall 321 of the first gas pipeline 307. In this situation, gas in the first gas pipeline 307 is still able to enter the fourth gas pipeline 310 through gas outlets 325 of other branch airways. Subsequently, other gas outlets 325 are blocked one by one downwardly by the inner wall 321 of the first gas pipeline 307 until all gas outlets 325 of the first valve plug are blocked so that the first gas pipeline 307 is completely separated from the fourth gas pipeline 310. By arranging at least two gas outlets, the whole pressure regulating device can be closed in a stepwise manner. Thus, a stepwise braking of the motor vehicle can be achieved, thereby preventing the motor vehicle from being shocked and subsequently damaged due to direct closure of the pressure regulating device.

As to the pressure regulating device, the first valve plug 302 has a first position, a second position and at least two third positions. When the first valve plug 302 is at the first position, it blocks the first gas pipeline 307 to disconnect the first gas pipeline 307 from the fourth gas pipeline 310 and none of the gas outlets communicates with the first chamber 305. When the first valve plug 302 is at the second position, the inner wall of the first gas pipeline 307 is apart from all the gas outlets so that all the gas outlets communicate with the first chamber 305, and the first valve plug 302 leaves the first gas pipeline 307. The situation “the first valve plug 302 leaves the first gas pipeline 307” may comprise that the first valve plug 302 moves down to completely exit from the first gas pipeline 307, or that a part of the first valve plug 302 extends upwards into the first gas pipeline 307. When the first valve plug 302 is at the third position, at least one gas outlet is blocked by the inner wall of the first gas pipeline 307 and at least one gas outlet is apart from the inner wall. Namely, some gas outlets communicate with the first chamber 305, whilst the rest outlets are disconnected from the first chamber 305. The situation “the first valve plug 302 blocks the first gas pipeline 307” may be that all the gas outlets are blocked by the inner wall of the first gas pipeline 307, or that the first valve plug 302 blocks an outlet 335 of the first gas pipeline 307.

FIG. 12 illustrates a fourth embodiment of the pressure regulating device, which differs from the third embodiment mainly in that the cross section of the branch airway 323 is circular.

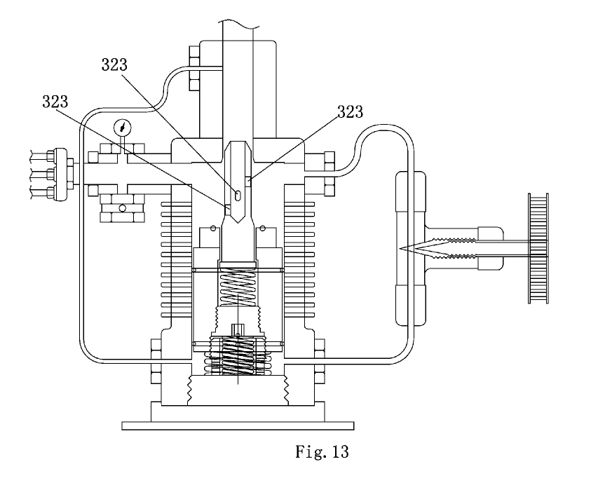

FIG. 13 illustrates the fifth embodiment of the pressure regulating device, which differs from the third embodiment mainly in that the cross section of the branch airway 323 has a shape like a racetrack.

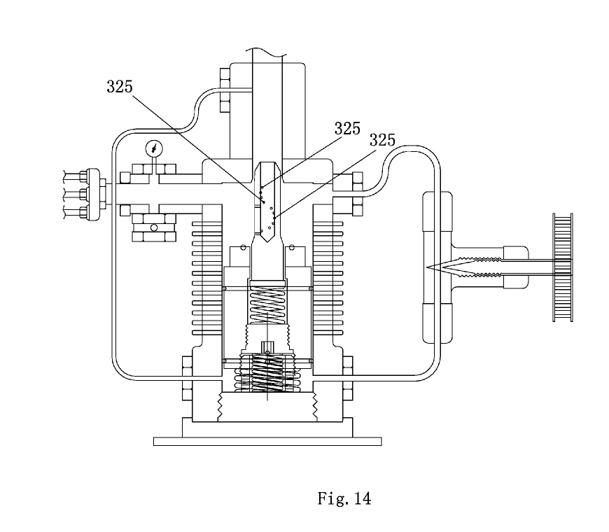

FIG. 14 illustrates the sixth embodiment of the pressure regulating device, which differs from the second embodiment mainly in that the distribution of all the gas outlets 325 constitutes a sinusoid.

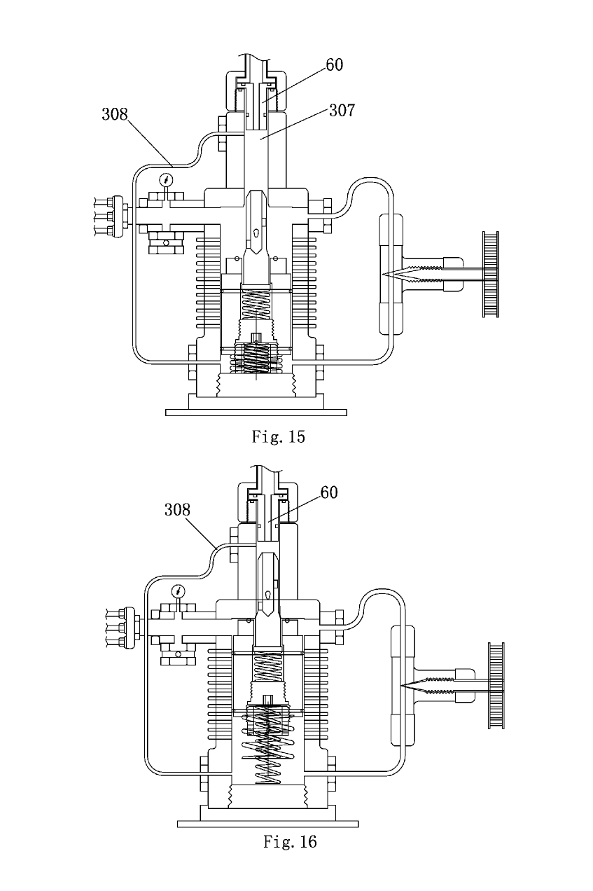

FIG. 15 and FIG. 16 illustrate a seventh embodiment of the pressure regulating device, which differs from the first to sixth embodiments mainly in that a flow limiting tube 60 is provided within the first gas pipeline 307. The compressed air in the compressed air tank enters the second gas pipeline 308 through the flow limiting tube 60 and a first gas pipeline 307. For motor vehicles with different emission, only a change of flow limiting tubes with different pipe diameters is necessary, thereby realizing the standardized production of motor vehicles.

The pressure regulating device comprises a first valve seat and a first valve plug. The first valve plug is arranged inside a cavity of the first valve seat to slidably and sealing fitted with the first valve seat and divide the cavity into a first chamber and a second chamber. The first chamber may be connected to a first gas pipeline which is used for air intake. A second elastic body may be provided within the second chamber to support the first valve plug. A plurality of branch airways with gas outlets may be arranged in the first valve plug. The first valve plug may have a first position, a second position and at least two of third positions between the first position and the second position along the sliding direction of the first valve plug. When the first valve plug is at the first position, it blocks the first gas pipeline so as to render gas in the first gas pipeline unable to enter the first chamber. When the first valve plug is at the second position, the inner wall of the first gas pipeline leaves all the gas outlets, rendering the first gas pipeline communicating with the first chamber. When the first valve plug is at the third position, at least one gas outlet communicates with the first chamber and at least one gas outlet is blocked by the inner wall of the first gas pipeline. When the first valve plug moves upwards, the inner wall of the first gas pipeline can gradually block up all the gas outlets from top to bottom, thereby realizing stepwise closure of the pressure regulating device, which effectively mitigates the strike force generated by the closure of the pressure regulating device and hence improve the life of the reducing valve. When the first valve plug moves downwards, all the gas outlets are opened in a stepwise manner from the bottom gas outlet to the top gas outlet, rendering an stepwise increasing of gas flux entering the first chamber, which facilitates an easy control of the pressure regulating device. The structure of the pressure regulating device can be applied in an environment which needs a cooperation of a valve plug and an inner wall of a gas pipeline to achieve the closure of the gas path. Moreover, gas outlets are distributed linearly or in a curve along the sliding direction of the first valve plug, and may be in the same plane or in multiple planes.

Although the above description makes explanation in detail for the present application in reference to preferred embodiments, the practice of the present application should not be construed to be limited to these descriptions. A person skilled in the art can make various simple deductions or replacements without departing from the spirit and concept of the present application, which should be construed to fall into the scope of the appended claims of the present application.

1-20. (canceled)

21. A pressure regulating device, comprising a control valve and a controller,
wherein the control valve comprises:
a first valve seat having a cavity,
a first valve plug provided within the cavity dividing the cavity into a first chamber and a second chamber, the first valve plug slidably and sealingly fitted with the first valve seat,
a second elastic body provided within the second chamber and supporting the first valve plug,
a first gas pipeline communicating with the first chamber,
a second gas pipeline connected to the first gas pipeline and the second chamber,
a third gas pipeline connected to the first chamber and the second chamber, having a cross section greater than that of the second pipeline, and
a fourth gas pipeline communicating with the first chamber;
wherein the controller is connected to the third gas pipeline to control the flow of the third gas pipeline, and
wherein the first valve plug blocks the first gas pipeline at a first position along a sliding direction to disconnect the first gas pipeline from the first chamber, and is apart from the first gas pipeline at a second position along the sliding direction to make the first gas pipeline communicate with the first chamber.

22. The pressure regulating device according to claim 21, wherein the first valve plug comprises a main body and a closing portion supported on the main body, wherein the main body is slidably and sealingly fitted with the first valve seat, the closing portion has a diameter less than that of the main body and is provided within the first chamber to block up the first gas pipeline when the first valve plug is at the first position and leave the first gas pipeline when the first valve plug is at the second position.

23. The pressure regulating device according to claim 22, wherein the first control valve further comprises a first elastic body through which the closing portion is supported on the main body.

24. The pressure regulating device according to claim 23, wherein the main body has an inner chamber axially running therethrough, the bottom of the inner chamber is closed by a first positioning block, the first positioning block is thread fitted with the main body, the first elastic body is provided in the inner chamber, the first elastic body is connected at one end to the first positioning block and at another end to the closing portion, respectively, the second elastic body is connected at one end to the bottom of the second chamber and the first positioning block.

25. The pressure regulating device according to claim 23, wherein a third elastic body is provided under the first valve plug and within the second chamber to be held against the first valve plug at one end and the first valve seat at another end, wherein the third elastic body is suspended when the first valve plug is at the first position the first position and compressed when the first valve plug is at the second position.

26. The pressure regulating device according to claim 23, wherein a first elastic sealing ring is provided at the peripheral surface of the main body, through which the main body is slidably and sealingly fitted with the first valve seat.

27. The pressure regulating device according to claim 23, wherein a second elastic sealing ring is provided at the top end surface of the main body, and the second elastic sealing ring clings to the first valve seat when the first valve plug is at the first position so as to facilitate disconnecting the first gas pipeline from the first chamber.

28. The pressure regulating device according to claim 23, wherein the closing portion has at least two branch airways, a gas inlet of each branch airway communicates with the first gas pipeline, each branch airway has a gas outlet provided on a peripheral surface of the closing portion, the first valve plug further comprises at least two third positions; and
wherein the first valve plug blocks the first gas pipeline at the first position to disconnect the first gas pipeline from the first chamber, and moves away from the first gas pipeline at the second position to make the first gas pipeline and all the outlets communicate with the first chamber, and when the first valve plug is at the third position, at least one of the gas outlets is blocked by the inner wall of the first gas pipeline, whilst at least one of other gas outlets communicates with the first chamber.

29. The pressure regulating device according to claim 28, wherein the closing portion further comprises a main airway, each of the branch airways communicates with the main airway, and each of the gas inlets communicates with the first gas pipeline through the main airway.

30. The pressure regulating device according to claim 29, wherein the main airway extends along an axial direction of the closing portion, and the branch airways radially run through the closing portion.

31. The pressure regulating device according to claim 21, wherein the controller has a second valve plug and a second valve seat, the second valve plug has a second main body and a cone body provided at the front end of the second main body, the second valve seat has a gas passage with its inlet and outlet being communicating with the third gas pipeline, and a control cavity cone-shaped corresponding to the cone body is provided within the gas passage and is thread fitted with the second main body.

32. The pressure regulating device according to 27, wherein a flow limiting tube is provided within the first gas pipeline.

33. A pressure regulating device, comprising a control valve and a controller,
wherein the control valve comprises:
a first valve seat having a cavity,
a first valve plug provided within the cavity dividing the cavity into a first chamber and a second chamber, the first chamber outputting gas through a conduit,
a second elastic body provided within the second chamber, connected at one end to the first valve seat and at another end to the first valve plug,
a first gas pipeline having a junction with the first chamber,
a second gas pipeline communicating at one end with the first gas pipeline and at another end with the second chamber, and
a third gas pipeline communicating at one end with the first chamber and at another end with the second chamber;
wherein the first valve plug blocks the junction at a first position, and is apart from the first gas pipeline at a second position, and
wherein the controller is provided within the third gas pipeline and is provided with a second valve seat and a second valve plug being controlled and movable with respect to the second valve seat, and the second valve plug, along its motion track, has a position in which the third gas pipeline is blocked and a position in which the third gas pipeline is unblocked.

34. The pressure regulating device according to claim 33, wherein the first valve plug comprises a main body and a closing portion supported on the main body, wherein the main body is slidably and sealingly fitted with the first valve seat, the closing portion has a diameter less than that of the main body and is provided within the first chamber to block up the first gas pipeline when the first valve plug is at the first position and leave the first gas pipeline when the first valve plug is at the second position.

35. The pressure regulating device according to claim 34, wherein the first control valve further comprises a first elastic body through which the closing portion is supported on the main body.

36. The pressure regulating device according to claim 35, wherein the main body has an inner chamber axially running therethrough, the bottom of the inner chamber is closed by a first positioning block, the first positioning block is thread fitted with the main body, the first elastic body is provided in the inner chamber, the first elastic body is connected at one end to the first positioning block and at another end to the closing portion, respectively, the second elastic body is connected at one end to the bottom of the second chamber and the first positioning block.

37. The pressure regulating device according to claim 34, wherein a third elastic body is provided under the first valve plug and within the second chamber to be held against the first valve plug at one end and the first valve seat at another end, wherein the third elastic body is suspended when the first valve plug is at the first position the first position and compressed when the first valve plug is at the second position.

38. The pressure regulating device according to claim 34, wherein a first elastic sealing ring is provided at the peripheral surface of the main body, through which the main body is slidably and sealingly fitted with the first valve seat.

39. The pressure regulating device according to claim 34, wherein a second elastic sealing ring is provided at the top end surface of the main body, and the second elastic sealing ring clings to the first valve seat when the first valve plug is at the first position so as to facilitate disconnecting the first gas pipeline from the first chamber.

40. The pressure regulating device according to claim 34, wherein the closing portion has at least two branch airways, a gas inlet of each branch airway communicates with the first gas pipeline, each branch airway has a gas outlet provided on a peripheral surface of the closing portion, the first valve plug further comprises at least two third positions; and
wherein the first valve plug blocks the first gas pipeline at the first position to disconnect the first gas pipeline from the first chamber, and moves away from the first gas pipeline at the second position to make the first gas pipeline and all the outlets communicate with the first chamber, and when the first valve plug is at the third position, at least one of the gas outlets is blocked by the inner wall of the first gas pipeline, whilst at least one of other gas outlets communicates with the first chamber.

41. The pressure regulating device according to claim 40, wherein the closing portion further comprises a main airway, each of the branch airways communicates with the main airway, and each of the gas inlets communicates with the first gas pipeline through the main airway.

42. The pressure regulating device according to claim 41, wherein the main airway extends along an axial direction of the closing portion, and the branch airways radially run through the closing portion.

43. The pressure regulating device according to claim 33, wherein the controller has a second valve plug and a second valve seat, the second valve plug has a second main body and a cone body provided at the front end of the second main body, the second valve seat has a gas passage with its inlet and outlet being communicating with the third gas pipeline, and a control cavity cone-shaped corresponding to the cone body is provided within the gas passage and is thread fitted with the second main body.

44. The pressure regulating device according to claim 33, wherein a flow limiting tube is provided within the first gas pipeline.

45. A pressure regulating device, comprising:
a first valve seat having a cavity,
a first valve plug provided within the cavity dividing the cavity into a first chamber and a second chamber, the first valve plug slidably and sealingly fitted with the first valve seat,
a second elastic body provided within the second chamber, supporting the first valve plug, and
a first gas pipeline communicating with the first chamber;
wherein a portion of the first valve plug located inside the first chamber has at least two branch airways, each branch airway has a gas outlet and a gas inlet communicating with the first gas pipeline; and
wherein the first valve plug has a first position, a second position and at least two third positions along its sliding direction, when the first valve plug is at the first position, all the gas outlets are blocked by an inner wall of the first gas pipeline; when the first valve plug is at the second position, the inner wall of the first gas pipeline is apart from all the gas outlets; and when the first valve plug is at the third position, at least one of the gas outlets is blocked by the inner wall of the first gas pipeline whilst at least one of other gas outlets is apart from the inner wall.

46. The pressure regulating device according to claim 45, wherein the first valve plug comprises a main body and a closing portion having a diameter less than that of the main body, the main body is slidably and sealingly fitted with the first valve seat, the closing portion is provided within the first chamber, and each branch airway is arranged in the closing portion.

47. The pressure regulating device according to claim 46, wherein the closing portion further comprises one main airway, each of the branch airways communicates with the main airway, each of the gas inlets communicates with the first gas pipeline through the main airway.

48. A compressed air supply system comprising a compressed air tank and a gas distributor for feeding compressed air to a pneumatic engine, wherein the system further comprises a pressure regulating device according to claim 1 connected to the compressed air tank and the gas distributor.

49. A compressed air supply system comprising a compressed air tank and a gas distributor for feeding compressed air to a pneumatic engine, wherein the system further comprises a pressure regulating device according to claim 13 connected to the compressed air tank and the gas distributor.

50. A motor vehicle comprising a pneumatic engine, wherein the motor vehicle further comprises a compressed air supply system according to claim 28, the gas distributor of the compressed air supply system being connected to the pneumatic engine.

51. A motor vehicle comprising a pneumatic engine, wherein the motor vehicle further comprises a compressed air supply system according to claim 29, the gas distributor of the compressed air supply system being connected to the pneumatic engine.
